(19) United States
(12) Patent Application Publication
(10) Pub. No.: US 2023/0391428 A1
(43) Pub. Date: Dec. 7, 2023

(54) AN ANTI-FOULING PROTECTIVE COVER

(71) Applicant: MARINE PRO AS, Stemmestad (NO)

(72) Inventors: Trond STENSLET, Slemmestad (NO); Erling ERIKSEN, Borgen (NO)

(73) Assignee: MARINE PRO AS, Slemmestad (NO)

(21) Appl. No.: 18/034,691

(22) PCT Filed: Nov. 1, 2021
(86) PCT No.: PCT/EP2021/080266

§ 371 Date: Apr. 29, 2023

(30) Foreign Application Priority Data
Nov. 6, 2020 (NO) 20201210

(51) Int. Cl. B63B 59/04; B32B 7/09; B32B 7/12; B32B 3/08; B32B 9/02; B32B 9/04

(52) U.S. Cl. CPC B63B 59/045; B32B 7/09; B32B 7/12; B32B 3/08; B32B 9/02; B32B 9/045; B32B 2262/065; B32B 2307/7145

(57) ABSTRACT

An anti-fouling protective cover (10) configured to abut against a boat hull (1) below the sea surface (3) for fouling-reducing protection of the boat hull, comprising a main sheet (10b). It may comprise one or more cover foils (10a) configured to be separated from the antifouling protective cover (10).

### TECHNICAL FIELD

The present invention relates to an anti-fouling protective cover that prevents fouling on submerged parts of boat hulls.

### BACKGROUND ART

Most objects that are submerged in seawater for some time will experience fouling on their surfaces. This is a known problem for boats. A boat hull with fouling will be heavier and will move slower through the water due to increased friction. This increases fuel consumption and thus emissions, such as CO₂ and NOₓ.

Consequently, it is common to cover the submerged part of the hull with an antifouling agent (paint or other coating) to inhibit the growth of marine organisms on the boat hull.

The antifouling products are typically made with polymers (oil- or resin materials) with biocides added. Such an antifouling agent may typically comprise toxic components such as copper, zinc, tin or led. The increased environmental awareness has resulted in a growing number of nations banning the use of this kind of biocides on recreational boats.

While reducing fouling on the hull, the antifouling agent will eventually detach from the hull. This may occur during normal use or during re-coating of the hull. The toxic components will then—typically—end up in the sea.

Self-polishing antifouling agents will lose up to 80% of the seasonal coating amount painted. Hard antifouling agents will stay longer but will lose its ability to prevent growth of marine fouling on the underwater surface of the hull.

It is thus desirable to avoid the use of toxic antifouling agents.

A solution to this problem is presented in patent publication EP2310258 B1. A flexible cover, such as a textile, is arranged in the sea. A boat is then moved above the cover, such that the boat hull is in close contact with the cover. The cover is impermeable to light, so that organisms that are dependent on light cannot grow on the hull surface.

Application publication EP2848516 A1 discloses a similar solution. In this solution, the flexible cover is made up of distinct parts, such that the total areal of the cover can be adjusted.

In addition to prevent light from reaching the underwater surface of the hull, it is advantageous that the cover provides some abrasive function. When the boat is moored, typically at a floating pier, waves will provide some relative movement between the boat hull and the flexible cover. The abrasive function of the cover will then contribute to maintaining the hull free of fouling.

While the said known art provides effective means for preventing the formation of fouling on the boat hull, a problem still exists due to fouling on the flexible cover itself.

The surface of the cover that faces the hull will be arranged in darkness. This surface will furthermore be exposed to some abrasive function when sliding against the hull. This surface will thus not be exposed to fouling. However, the opposite side, i.e. the surface facing the seabed, is exposed to light and experiences no abrasive function. This surface will thus be exposed to fouling. Hence, the flexible cover must be removed from its position to be cleaned. The fouling on the flexible cover may have a substantial mass which makes such a cleaning cumbersome.

Another problem with the added weight resulting from the fouling on the flexible cover, is that it tends to sink in the water since it loses buoyancy. This creates a reduced contact between the cover and the boat hull.

An object of the present invention may be to provide a flexible cover of the type defined in the introductory part of claim 1, which addresses the problem resulting from fouling on the flexible cover.

### SUMMARY OF INVENTION

According to the present invention, there is provided an anti-fouling protective cover configured to abut against a boat hull below the sea surface for fouling-reducing protection of the boat hull. The protective cover comprises a main sheet.

Advantageously, the anti-fouling protective cover is impermeable or semi-impermeable to light. Reducing the amount of light that reaches the boat hull will contribute to reduce fouling on the boat hull.

Preferably, the protective cover can comprise one or more cover foils configured to be separated from the anti-fouling protective cover. With such cover foils, fouling that occurs on the protective cover can easily be removed by tearing off one cover foil.

The one or more cover foils can be attached with a releasable glue and/or stitching. Other means for connection are also possible, such as welding.

Preferably, in some embodiments the main sheet can comprise coir. As will be discussed further below, coir exhibits several advantageous features, such as an abrasive function and being environmentally friendly.

The protective cover according to the invention can in some embodiments comprise a first surface configured to face the boat hull and a second opposite surface, wherein the first surface comprises abrasive elements, such as fibers or particles.

In some embodiments the main sheet can comprise buoyancy elements along its periphery, exhibit a density less than water, or it can comprise buoyancy parts integrated in the main sheet. In this manner the main sheet will be buoyant in water. Providing the protective cover with buoyancy contributes in obtaining contact between the protective cover and the boat hull.

In some embodiments, the protective cover can further comprise elastic elements along its periphery. As will be discussed further below, by attaching the protective cover via the elastic elements, one can facilitate the installation of a boat above the protective cover. The elastic elements may also protect the protective cover from excessive forces resulting from boat movement.

In some embodiments, the main sheet can have an attachment rim that is not covered with said cover foil. Such an attachment rim may be useful for attachment of the protective cover.

In some embodiments, the cover foil can be in the form of a plastic foil. In other embodiments, the cover foil or foils can be made of a biodegradable material, for instance natural textiles.

The protective cover may in some embodiments further comprise a buoyancy sheet, wherein the buoyancy sheet is arranged between the main sheet and said cover foil. The buoyancy sheet is buoyant in water, as it has a specific gravity less than one. Preferably it is made of or comprises an environmentally friendly material, such as cork or balsawood.

According to a second aspect of the present invention, there is provided a method of removing fouling from an anti-fouling protective cover according to the first aspect of the invention. The method comprises removing a cover foil exposed to said fouling.

### DETAILED DESCRIPTION OF THE INVENTION

While the present invention has been discussed in general terms above, a more detailed and non-limiting example of embodiment will be presented in the following with reference to the drawings, in which

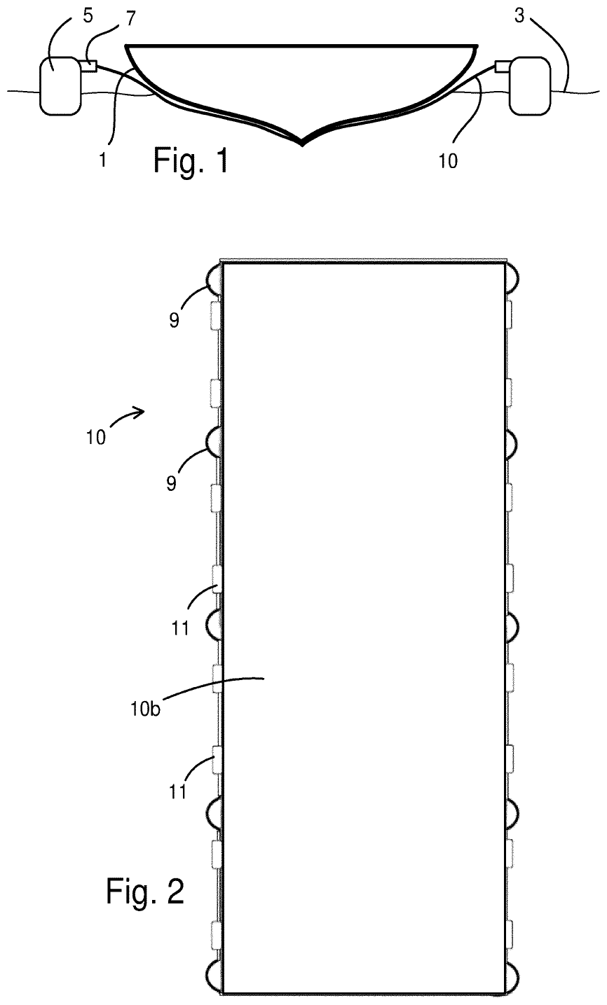

FIG. 1 is a cross section front view of a boat hull floating on the sea, with a protective cover contacting the hull surface;

FIG. 2 is a schematic top view of the protective cover; and

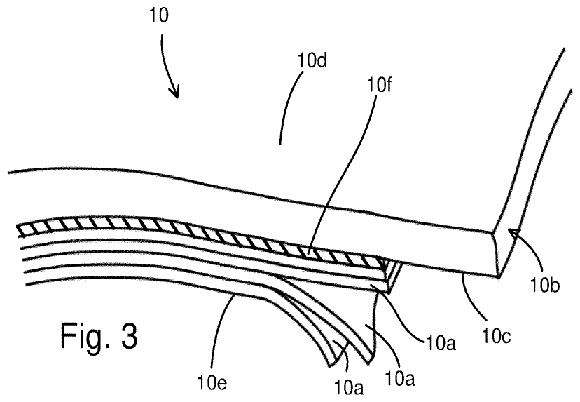

FIG. 3 is a schematic illustration showing a portion of a protective cover according to the invention.

FIG. 1 depicts a boat hull 1 floating on the sea surface 3 and extending partly into the sea. In the shown example, the boat hull 1 is positioned between two pontoon piers 5, which is typically used for mooring leisure boats.

Extending between the pontoon piers 5 is a protective cover 10. The protective cover 10 extends longitudinally along the entire or at least a portion of the length of the boat hull 1. Furthermore, the protective cover 10 is in the shown embodiment connected at a position above the sea surface 3, thus extending through the sea surface 3.

The protective cover 10 is connected with fastening means 7. In the shown embodiment, the fastening means 7 connect to the pontoon piers 5.

The protective cover 10 is arranged in such a way that it will contact the wet part of the boat hull 1. Preferably, the protective cover 10 can be installed without the boat hull 1 being present, such that the boat can be moved onto the already installed protective cover 10. Also, the boat can preferably be moved off the protective cover 10 while the protective cover remains in place.

The protective cover 10 is impermeable to light. In this manner, marine growth is reduced. While it is preferred that the protective cover 10 is fully impermeable to light, it will be appreciated that a cover having some permeability will also contribute in reducing the marine growth.

FIG. 2 is a schematic top view of a protective cover 10 according to the invention. The size of the protective cover 10 will typically be adapted to the size of the boat hull and may thus vary. For instance, sizes of the protective cover 10 according to the invention may be in the range of 4 to 40 m², in the range of 8 to 30 m², or in the range of 4 to 20 m².

At the periphery of the protective cover 10 there are arranged a plurality of elastic elements 9. The elastic elements 9 are extensible, for instance in the form of elastic straps. The elastic elements 9 can be used for securing the protective cover 10 in a tensioned state. Thus, the elastic elements 9 will, when in a tensioned state, contribute to maintaining contact between the protective cover and the boat hull 1. The elastic elements 9 may for instance connect to the fastening means 7 shown in FIG. 1.

In addition to contributing to the contact between the protective cover 10 and the boat hull 1, the elastic elements 9 may also facilitate movement of a boat hull 1 onto the protective cover 10. This is because the elastic elements 9 will yield as the boat hull 1 forces the protective cover downwards in the water.

In some embodiments, to facilitate movement of the boat onto the protective mat 10, one or more weight elements (not shown) can be arranged to the protective cover 10, preferably at one rim of the mat where the boat enters the protective cover. The weight element(s) will then pull a portion of the protective cover 10 downwards to let the boat hull more easily move onto it. Once the boat is in place above the protective cover 10, the weight element(s) (or some of the weight elements) can be removed to let the protective cover 10 contact the boat hull 1.

In some embodiments, the entire protective cover 10 can be arranged below the sea surface 3. In other embodiments, the protective cover 10 can extend from a position above the sea surface 3 and into the sea.

Also shown in FIG. 2, along the periphery of the protective cover 10 are a plurality of buoyancy elements 11. The buoyancy elements 11 will be arranged in the sea and will contribute to providing contact between the protective cover and the boat hull 1. Preferably, the buoyancy elements 11 are made of an environmentally friendly material, such as cork. Embodiments without the shown buoyancy elements 11 are also possible.

FIG. 3 depicts an end portion of the protective cover 10 with a perspective view. The protective cover 10 comprises cover foils 10a and a main sheet 10b. The main sheet 10b is configured to be connected to the fastening means 7, for instance with the elastic elements 9.

In addition to the cover foils 10a and the main sheet 10b, the shown embodiment further includes a buoyancy sheet 10f. The buoyancy sheet 10f provides buoyancy to the protective cover 10. It can advantageously be made of a biodegradable material, such as for instance cork or balsawood.

The protective cover 10 exhibits a first surface 10d that is configured to contact the boat hull 1, and an oppositely facing second surface 10e.

The main sheet 10b is impermeable to light. This will contribute to reducing marine growth on the boat hull 1.

The main sheet 10b can advantageously be made of an environmentally friendly material. A preferred material may be coir. Coir is an advantageous material since it is durable, particularly in seawater. Moreover, it provides an abrasive function on the boat hull 1. In addition, it can be woven into a suitably stiff cover.

To provide the said relative movement between the protective cover 10 and the boat hull 1, the protective cover 10 needs to exhibit some stiffness. However, to ensure close contact with the boat hull 1, it is also advantageous that the protective cover 10 can adapt to the boat hull 1. It has been found that coir is a material suitable for providing both these features, while simultaneously being environmentally friendly.

The main sheet 10b further needs mechanical strength to withstand forces resulting e.g. from movement of the boat hull 1, or from the weight of fouling on the protective cover 10 itself. Coir meets all these requirements.

During said abrasive function on the boat hull 1, the protective cover 10 will experience wearing, as small parts of it may detach and end up in the sea. Using coir, typically as a coir mat, as the abrasive surface, is thus environmentally friendly.

Still referring to FIG. 3, while the first surface 10d faces the boat hull 1, the opposite second surface 10e will face water and will be exposed to light. Consequently, the second surface 10e of the protective cover 10 will be exposed to fouling. To facilitate removal of such fouling on the protective cover 10, the protective cover 10 comprises one or more foils 10a. The foils 10a can be torn off the protective cover 10, while leaving possible other foils 10a and the main sheet 10b in place. Hence, when the protective cover 10 is exposed to fouling, the fouling can be swiftly removed by tearing off one foil 10a.

The cover foils 10a may be made of a plastic material. For instance, it may be made of a recycled plastic material. Since the cover foils 10a do not need to contribute in the mechanical integrity of the protective cover 10, they can be made thin. The cover foils 10a can be made impermeable or semi-impermeable to light.

For instance, the thickness of the cover foils 10a can be in the range of 15 to 200 μm.

The main sheet 10b may advantageously comprise an attachment rim 10c. The attachment rim 10c is an edge portion of the main sheet 10b where the cover foils 10a are not located. The attachment rim 10c hence provides a suitable area for attachment of the main sheet 10b to the fastening means 7. For instance, the elastic elements 9 can be attached to the attachment rim 10c.

In some embodiments, the main sheet 10b may comprise integrated buoyancy means (not shown). For instance, the main sheet 10b may be a woven coir mat, and buoyancy parts may be integrated in the coir mat. Such buoyancy parts can advantageously be made of an environmentally friendly material, for instance cork. Thus, in such embodiments, the main sheet 10b is made of natural products, even with embodiments having integrated buoyancy parts.

The cover foils 10a can be attached in different ways. For instance, they can be glued to adjacent foils 10a with a glue or adhesive that maintains the foils 10a in place but permits the respective foils to be torn off. Alternatively, or in addition, the cover foils 10a can be stitched to each other, such as along their periphery.

In some embodiments, the cover foils 10a can comprise rows of perforations along their periphery, such that they can be torn off along such rows (i.e. like a perforated piece of paper).

1. An anti-fouling protective cover configured to abut against a boat hull below the sea surface for fouling-reducing protection of the boat hull, the anti-fouling protective cover comprising a main sheet.

2. The anti-fouling protective cover according to claim 1, comprising one or more cover foils configured to be separated from the anti-fouling protective cover.

3. The anti-fouling protective cover according to claim 2, wherein the one or more cover foils are attached with at least one of a releasable glue and stitching.

4. The anti-fouling protective cover according to claim 1, wherein the main sheet comprises coir.

5. The anti-fouling protective cover according to claim 1, comprising a first surface configured to face the boat hull and a second opposite surface, wherein the first surface comprises abrasive elements.

6. The anti-fouling protective cover according to claim 1, wherein the main sheet comprises at least one of:
buoyancy elements along its periphery;
a density less than water; and
buoyancy parts integrated in the main sheet;
such that the main sheet is buoyant in water.

7. The anti-fouling protective cover according to claim 1, comprising elastic elements along a periphery thereof.

8. The anti-fouling protective cover according to claim 2, wherein the main sheet comprises an attachment rim that is not covered with the cover foil.

9. The anti-fouling protective cover according to claim 2, wherein the cover foil is in the form of a plastic foil.

10. The anti-fouling protective cover according to claim 1, comprising a buoyancy sheet, wherein the buoyancy sheet is arranged between the main sheet and the cover foil.

11. A method of removing fouling from an anti-fouling protective cover according to claim 1, comprising removing a cover foil exposed to the fouling.

12. The anti-fouling protective cover according to claim 5, wherein the abrasive elements comprise at least one of fibers and particles.
